(19) United States
(12) Patent Application Publication
(10) Pub. No.: US 2016/0361225 A1
(43) Pub. Date: Dec. 15, 2016

(54) Sex toy with depth measurement markings

(71) Applicant: Brian Dugan, Philadelphia, PA (US)

(72) Inventor: Brian Dugan, Philadelphia, PA (US)

(21) Appl. No.: 15/181,343

(22) Filed: Jun. 13, 2016

Related U.S. Application Data
(60) Provisional application No. 62/175,227, filed on Jun. 13, 2015.

(51) Int. Cl. A61H 19/00; A61H 23/02

(52) U.S. Cl. CPC A61H 19/44; A61H 23/02; A61H 2201/0111; A61H 2201/1253

(57) ABSTRACT

A sex toy that uses a pattern of colors, shapes, numbers, symbols, or any combination thereof to provide depth measurement markings in inches or centimeters which are easily read in darkness. An indication of circumference is at the base. The sex toy is preferably manufactured from a flexible, durable material which is waterproof and easily cleaned. The markings are provided in alternating or contrasting color schemes, such as blue and yellow, or shapes such as triangles stacked on top of each other such that they may be easily read in reduced lighting conditions.

### CROSS-REFERENCE TO RELATED APPLICATIONS

This application claims the benefit of U.S. Provisional Application No. 62/175,227, filed Jun. 13, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to sex toys and in particular to a sex toy with depth measurement markings. Sex toys for insertion into a body cavity are gaining popularity due to their recent portrayal in erotic romance books and films. Unfortunately, inexperienced users or users who are using the sex toy with a new partner, frequently insert these sex toys into a body cavity to a depth which is uncomfortable, resulting in soreness and injuries.

A search of the prior art reveals various sex toys which have been developed. None are closely related to the present invention, but several include features which resemble those of the present invention. Each has proven to be less than satisfactory in its own way.

Electronic variable stroke devices and system for remote control and interactive play, U.S. Pat. No. 8,308,631 (priority Oct. 17, 2002), provides an electronic variable stroke device comprising a base portion containing a motor-driven screw shaft, an upper portion extending from the base portion having the screw shaft extending longitudinally therein, and a traveler engaged with the screw shaft to drive it in reciprocating longitudinal motion. The traveler has an annular shape with an aperture there through which is driven in reciprocating longitudinal motions for use as a male sex toy. The device configuration may include a pair of screw threads spaced apart in parallel with the traveler engaged in between them, and/or multiple travelers arranged at different longitudinal positions of the screw shaft(s). A remote controller unit may be provided for ergonomic operation by the user. A network connection unit may be provided to connect the user's device to an external service provider on a network for conducting interactive sessions remotely with another user or users.

Sex training device and game, U.S. Patent App. Pub. No. US2014/0135573 (filed Nov. 11, 2012), provides a sex therapy device comprising a base made of a firm material and covered with a soft covering. Attached at various locations are connectors to which either cylinder extenders or dildo shape extensions may be connected. With the various locations of the connectors, a large number of penetration positions can be achieved to maximize the pleasure and sexual therapy of the user.

Modular sex toys, U.S. Patent App. Pub. No. US2006/0141903 (priority Dec. 23, 2004), provides a method and apparatus for selection of a modular sex toy. In one embodiment, an apparatus suitable for use in sexual situations is provided. The apparatus includes a base module having a modular interface. The apparatus also includes a main tool interchangeably coupled to the modular interface of the base module. The apparatus further includes a housing interchangeably coupled to the main tool and surrounding exposed surfaces of the main tool. In other embodiments, the apparatus is provided with a base and modular attachments, including a motor and components coupling the motor to the main tool and any attachments. Such embodiments may also include a power supply. In further embodiments, a method of selecting a sex toy by selecting components or characteristics is provided. In additional embodiments, a method of selecting a sex toy by responding to questions is provided. In other embodiments, a facility where modular sex toys may be assembled is provided.

Gas missile, U.S. Patent App. Pub. No. US2014/0171842 (priority Dec. 14, 2012), provides an adjustable personal vibrating stimulator which includes a main handle portion, a middle portion connected to the main handle portion, a movable handle portion, a cylinder-shaped member connected to the movable handle portion, and a tip connected to the middle portion. The main handle portion is movable relative to the movable handle portion. The stimulator further includes a G spot stimulator disposed on said cylinder-shaped member, such that the G spot stimulator is movable relative to the tip. The handles can be moved in the same direction or once inserted, may be moved in opposing directions at the same time.

Dual-motion auto-stimulation device, U.S. Pat. No. 6,902,525 (filed Dec. 30, 2003), provides a device designed to take rotary power from an external power source such as a cordless electric screwdriver and transmit that energy into both rotary and reciprocating linear activation of sexual devices, used by both males and females for the purpose of masturbation and auto-stimulation. The combination of rotational stimulation with reciprocating linear stimulation is apparently remarkably satisfying despite the absence of such stimulation during normal person-on-person sexual contact. The device is simple, light weight, small, powerful, modestly priced, handheld or hands-free, user serviceable, hygienic, gender neutral, sexual orientation neutral, convenient, rugged, multi-motion, safe, reliable, quiet, fully submersible, positionally versatile and sexually satisfying.

Masturbation toy capable of rotating 360 degrees, Chinese Patent No. CN202136549 (filed Jan. 21, 2011), provides a masturbation toy capable of rotating 360 degrees, which comprises a body, a power device, a rotating device and an elastic membrane. The body is provided with a controller, the power device is arranged in the body, the rotating device comprises a rotary shaft and a rotary cup, the rotary shaft is connected with the power device mechanically and can be driven to rotate by the power device, the rotary cup is connected with the rotary shaft, a plurality of friction elements are arranged on the surface of the elastic membrane in certain depth, and the elastic membrane is arranged in the rotary cup and extends into the rotary cup particularly. During use of the masturbation toy capable of rotating 360 degrees, a male user can penetrate his penis into the elastic membrane simulating a female vagina while starting the power device, so that the elastic membrane rotates along with the rotary cup, the penis and the balanus of the male user can be rubbed by the friction elements on the surface of the elastic membrane continuously, then the male user can get sexual pleasure different from the sexual pleasure generated when using existing female-vagina simulated masturbation toys, and sexual pleasure effect of existing sex appliances is improved.

Prior art inventions generally provide some sort of sex toy for insertion into a user's body cavity, but no method or means of measuring the depth of the insertion is provided to prevent injury. The present invention has been developed for the purpose of addressing and resolving the disadvantages of the prior art inventions. A sex toy with depth measurement markings, providing markings in inches or centimeters which are easily read in darkness, would resolve these problems.

### SUMMARY OF THE INVENTION

Accordingly, the invention is directed to a sex toy with depth measurement markings. The sex toy provides depth measurement markings in inches or centimeters which are easily read in darkness. The sex toy is preferably manufactured from a flexible, durable material which is waterproof and easily cleaned. The markings are provided in a contrasting color scheme, such as blue and yellow, and the sex toy may be provided in a variety of color schemes.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a left side view of the first exemplary embodiment, displaying the sex toy 10, the head 10A, and the markings 11.

FIG. 2 is a front view of the second exemplary embodiment, displaying the sex toy 10, the depth measurement markings 11A, and the girth measurement marking 11B.

FIG. 3 is a right side view of the first exemplary embodiment, displaying the sex toy 10, and the markings 11.

FIG. 4 is a rear view of the first exemplary embodiment, displaying the sex toy 10, and the depth measurement markings 11A.

FIG. 5 is a side view of the third exemplary embodiment, displaying the sex toy 10, and the triangular markings 11C.

FIG. 6 is a top view of the fourth exemplary embodiment, displaying the sex toy 10, the triangular markings 11C, and the alphanumeric characters 11D.

FIG. 7 is a top view of the fifth exemplary embodiment, displaying the sex toy 10, the tapered tip 10B, and the depth measurement markings 11A.

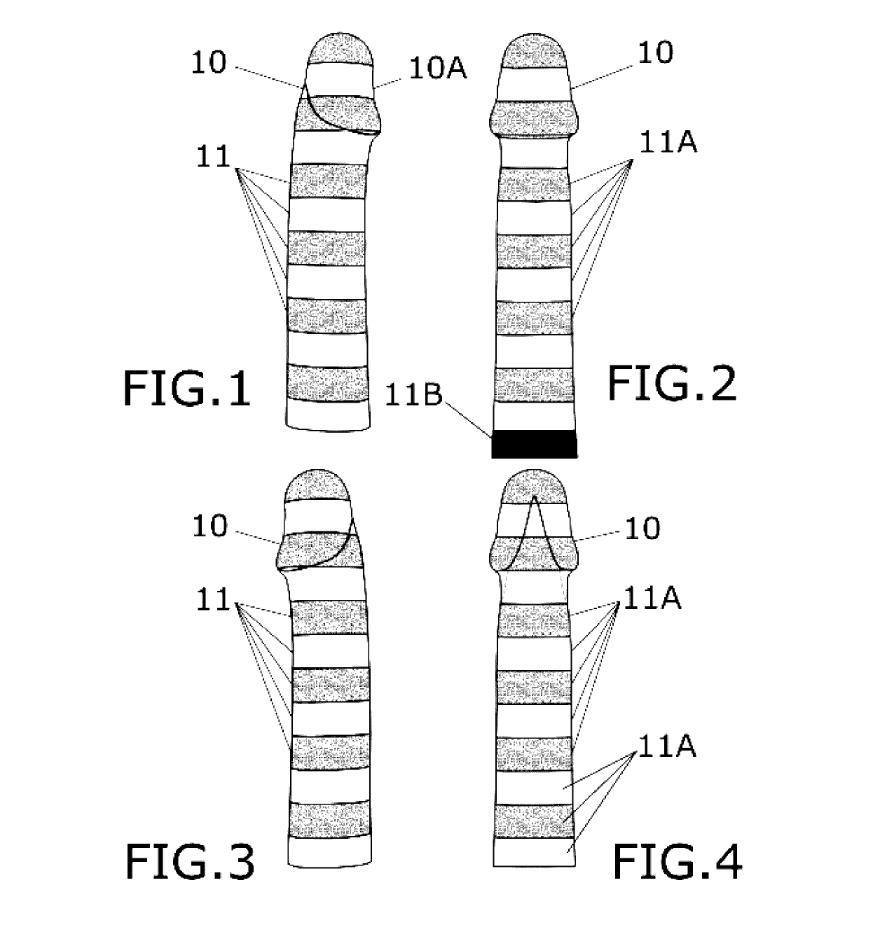

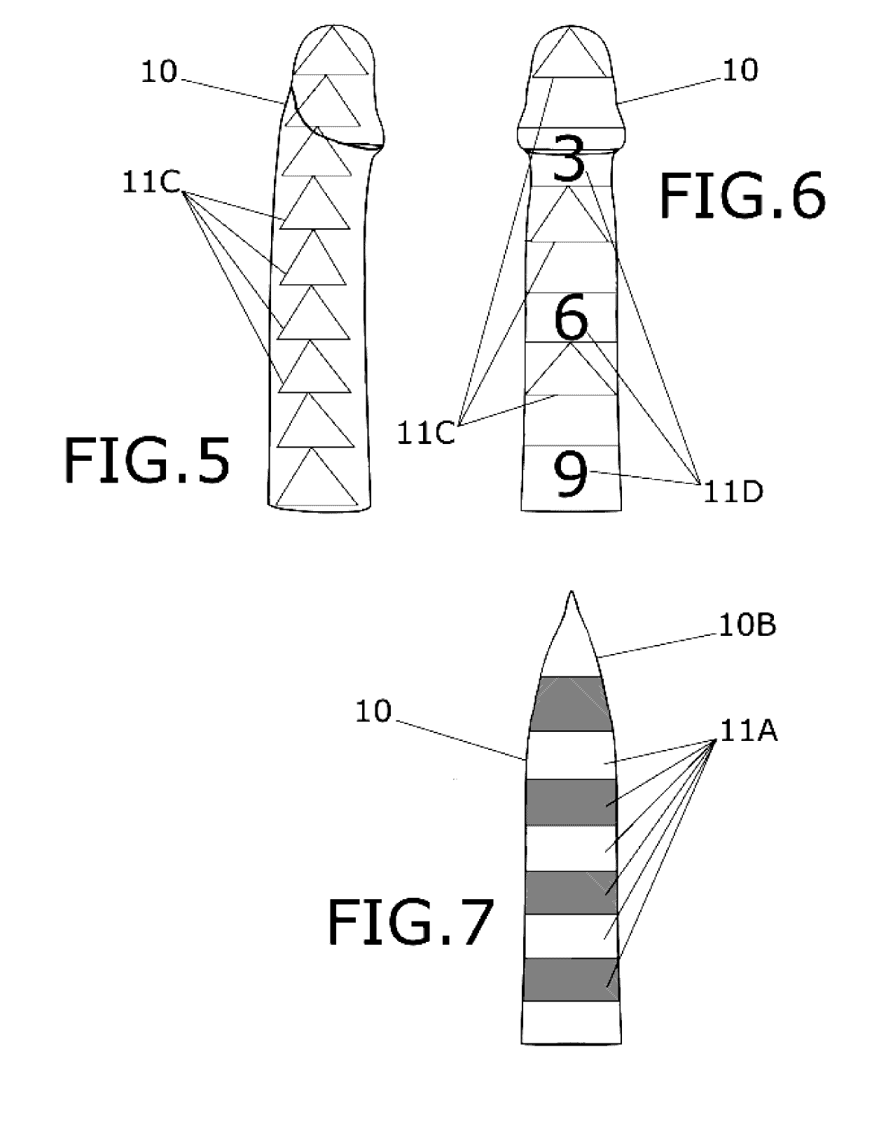

### DETAILED DESCRIPTION OF THE INVENTION

Referring now to the invention in more detail, the invention is directed to a sex toy 10 with depth measurement markings 11.

The first exemplary embodiment is comprised of a sex toy 10. The preferred embodiment of the invention is a dildo. Alternate embodiments, comprised of other types of insertive sex toys, are contemplated such as phallus shaped straws.

The first exemplary embodiment provides a single head 10A, and depth measurement markings 11A. The depth measurement markings 11A may be provided in inches or centimeters which are easily read in darkness. The sex toy 10 is preferably manufactured from a flexible, durable material which is waterproof and easily cleaned. The depth markings 11A can also be provided in a contrasting color scheme, such as blue and yellow, and the sex toy 10 may be provided in a variety of color schemes. A preferred embodiment of the invention is seven inches in length, with one-inch markings 11 in all the colors of the rainbow in the appropriate order. Other types of measurement markings 11, such as hash marks or one-inch-tall colored numerals, are also contemplated.

The second exemplary embodiment provides a sex toy 10 similar in structure and function to the first exemplary embodiment, wherein the lower end includes girth measurement markings 11B, which may include color-coded markings to indicate the diameter of the sex toy 10, such as red indicating a diameter of 1.5 inches and green representing a diameter of 1.75 inches. Alternatively, the girth measurement markings 11B may include measurements in inches or centimeters indicating the diameter of the sex toy 10 at that particular portion of the sex toy 10.

The first exemplary embodiment is provided in a single-headed hand-held version, in a variety of lengths and diameters. Alternate embodiments, such as a double-headed hand-held version or a strap-on version, are contemplated. Other alternate embodiments which may include an internal, battery-powered vibrating device, are also contemplated.

The third exemplary embodiment provides a sex toy 10 similar in structure and function to the first exemplary embodiment, wherein the depth measurement markings 11A are replaced by triangular markings 11C.

The fourth exemplary embodiment provides a sex toy 10 similar in structure and function to the first exemplary embodiment, wherein the depth measurement markings 11A are replaced by an alternating combination of depth measurement markings 11A, triangular markings 11C, and alphanumeric characters 11D. Other marking patterns are also contemplated.

The fifth exemplary embodiment provides a sex toy 10 similar in structure and function to the first exemplary embodiment, wherein the head 10A is replaced by a tapered tip 10B.

To use the first, second, third, fourth, or fifth exemplary embodiment, the user may insert the head 10A of the sex toy 10 into a body cavity and, upon reading the markings 11 on the portion of the sex toy which remains emergent, may calculate the depth to which the head 10A has been inserted. With this information, the user may determine whether to proceed, or withdraw the sex toy 10.

The sex toy 10 is preferably manufactured from a flexible, durable material which is waterproof and easily cleaned, such as silicone, rubber, or plastic, and may contain a semi-rigid or rigid core which is preferably manufactured from a semi-rigid or rigid durable material such as plastic, wood, or aluminum.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A sex toy with measurement markings, comprising a sex toy which may have a tapered tip or at least one head; said sex toy providing measurement markings.

2. The sex toy with measurement markings of claim 1, wherein said measurement markings include depth measurements; said depth measurements indicating a distance from the tip or a head of the sex.

3. The sex toy with measurement markings of claim 2, wherein said depth measurement markings are in inches.

4. The sex toy with measurement markings of claim 2, wherein said depth measurement markings are in centimeters.

5. The sex toy with measurement markings of claim 2, wherein said depth measurements are indicated by a pattern of alternating colors, shapes, symbols, numbers, or any combination of these elements.

6. The sex toy with measurement markings of claim 1, wherein said measurement markings include girth measurements; said girth measurements indicating a diameter of the sex toy.

7. The sex toy with measurement markings of claim 6, wherein said girth measurement markings are in inches.

8. The sex toy with measurement markings of claim 6, wherein said girth measurement markings are in centimeters.

9. The sex toy with measurement markings of claim 6, wherein said girth measurements are indicated by contrasting colors.

10. The sex toy with measurement markings of claim 2, wherein said measurement markings further indicate girth measurements; said girth measurements indicating a diameter of the sex toy.

11. The sex toy with measurement markings of claim 10, wherein said girth measurements are in inches.

12. The sex toy with measurement markings of claim 11, wherein said depth measurements are in inches.

13. The sex toy with measurement markings of claim 10, wherein said girth measurements are in centimeters.

14. The sex toy with measurement markings of claim 13, wherein said depth measurements are in centimeters.

15. The sex toy with measurement markings of claim 10, wherein said girth measurements are indicated by contrasting colors.

16. The sex toy with measurement markings of claim 15, wherein said depth measurements are indicated by contrasting colors.

17. The sex toy with measurement markings of claim 1, wherein said at least one head includes two heads; said measurement markings including depth markings; said depth markings indicating a distance from the nearest head.

18. The sex toy with measurement markings of claim 1, wherein said measurement markings further indicate girth markings; said girth markings indicating a diameter of the sex toy.

19. The sex toy with measurement markings of claim 1, wherein said sex toy is a dildo.

20. The sex toy with measurement markings of claim 1, wherein said sex toy is a phallus shaped straw.
